(19) United States
(12) Patent Application Publication
(10) Pub. No.: US 2025/0289186 A1
(43) Pub. Date: Sep. 18, 2025

(54) METHOD FOR MANUFACTURING THREE-DIMENSIONAL OBJECT

(71) Applicant: SEIKO EPSON CORPORATION, Tokyo (JP)

(72) Inventors: Koji FUJIMORI, Matsumoto (JP); Kazuya KITADA, Matsumoto (JP)

(21) Appl. No.: 19/077,076

(22) Filed: Mar. 12, 2025

(30) Foreign Application Priority Data
Mar. 14, 2024 (JP) 2024-039744

(51) Int. Cl. B29C 64/40; B29C 64/336; B33Y 10/00

(52) U.S. Cl. CPC B29C 64/40; B29C 64/336; B33Y 10/00

(57) ABSTRACT

A method for manufacturing a three-dimensional object includes a step of forming one or more sacrificial layers by ejecting a sacrificial layer material onto a stage, a step of forming an object by ejecting an object material onto the sacrificial layer, and a step of separating the object and the sacrificial layer. The sacrificial layer material and the object material are different materials. In the step of forming the sacrificial layer, the sacrificial layer, which includes the recessed portion into which a part of the object enters, is formed at least in a portion in contact with the object.

The present application is based on, and claims priority from JP Application Serial Number 2024-039744, filed Mar. 14, 2024, the disclosure of which is hereby incorporated by reference herein in its entirety.

### BACKGROUND

### 1. Technical Field

The present disclosure relates to a method for manufacturing a three-dimensional object.

### 2. Related Art

JP-A-2023-35401 discloses a method for manufacturing an object using a three-dimensional shaping apparatus, in which a sacrificial layer is formed on a stage and the object is shaped on the sacrificial layer. Adhesion is required between the sacrificial layer and the object in order to shape the object on the sacrificial layer.

However, in the method disclosed in JP-A-2023-35401, although adhesion between the sacrificial layer and the object is ensured, separability of separating the sacrificial layer and the object after shaping is lowered. That is, it is required to ensure both adhesion between the sacrificial layer and the object and separability between the sacrificial layer and the object.

JP-A-2023-35401 is an example of the related art.

### SUMMARY

A method for manufacturing a three-dimensional object including:
a step of forming one or more sacrificial layers by ejecting a first material onto a stage;
a step of forming an object by ejecting a second material onto the sacrificial layer; and
a step of separating the object and the sacrificial layer, wherein
the first material and the second material are different materials, and
in the step of forming the sacrificial layer, the sacrificial layer, which includes a recessed portion into which a part of the object enters, is formed at least in a portion in contact with the object.

### BRIEF DESCRIPTION OF THE DRAWINGS

FIG. 1 is a schematic diagram showing a configuration of a three-dimensional shaping apparatus.

FIG. 2A is a perspective view showing a schematic configuration of a flat screw.

FIG. 2B is a plan view showing a configuration of a barrel.

FIG. 3 is a plan view showing a configuration of a stage.

FIG. 4A is a side view showing a configuration of a sacrificial layer and an object.

FIG. 4B is an enlarged side view showing a portion A of the sacrificial layer and the object shown in FIG. 4A.

FIG. 5 is a flowchart showing a method for manufacturing a three-dimensional object.

FIG. 6A is a plan view showing the method for manufacturing the three-dimensional object.

FIG. 6B is a side view showing the method for manufacturing the three-dimensional object.

FIG. 7A is a plan view showing the method for manufacturing the three-dimensional object.

FIG. 7B is a side view showing the method for manufacturing the three-dimensional object.

FIG. 8A is a plan view showing the method for manufacturing the three-dimensional object.

FIG. 8B is a side view showing the method for manufacturing the three-dimensional object.

FIG. 9 is a plan view showing comparison of grid densities of the sacrificial layer.

FIG. 10 is a table for comparing and evaluating formation conditions of the sacrificial layer.

### DESCRIPTION OF EMBODIMENTS

Hereinafter, a configuration of a three-dimensional shaping apparatus 1000 and a method for manufacturing a three-dimensional object will be described with reference to the drawings. In the following drawings, three axes orthogonal to one another will be described as an X axis, a Y axis, and a Z axis. A direction along the X axis is an “X direction”, a direction along the Y axis is a “Y direction”, a direction along the Z axis is a “Z direction”, a direction of an arrow is a + direction, and a direction opposite to the + direction is a − direction. A view from the +Z direction or the −Z direction is also referred to as a plan view or planar.

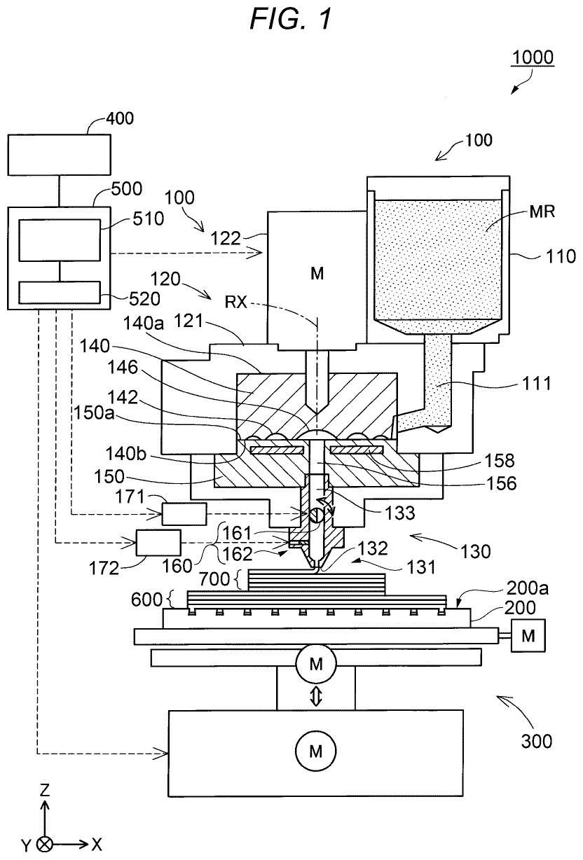

First, a configuration of the three-dimensional shaping apparatus 1000 will be described with reference to FIG. 1.

As shown in FIG. 1, the three-dimensional shaping apparatus 1000 is an apparatus that shapes an object 700 as a three-dimensional object by a material extrusion method. The three-dimensional shaping apparatus 1000 includes a shaping unit 100 that generates a shaping material and ejects the shaping material, a shaping stage 200 serving as a base for the three-dimensional object 700, a movement mechanism 300 that controls an ejection position of the shaping material, an information processing device 400, and a control unit 500 that controls each part of the three-dimensional shaping apparatus 1000.

The shaping unit 100 ejects a shaping material obtained by plasticizing a material in a solid state toward the stage 200 under the control of the control unit 500. The shaping unit 100 includes a material supply unit 110 that is a supply source of a raw material before being converted into the shaping material, a plasticizing unit 120 that converts the raw material into the shaping material, and an ejection unit 130 that ejects the shaping material.

The material supply unit 110 supplies a raw material MR to the plasticizing unit 120. The material supply unit 110 is implemented by, for example, a hopper that accommodates the raw material MR. The material supply unit 110 is coupled to the plasticizing unit 120 via a communication path 111. The raw material MR is put in the material supply unit 110 in a form of pellets, powder, or the like.

The plasticizing unit 120 plasticizes the raw material MR supplied from the material supply unit 110 to generate a paste-shaped shaping material exhibiting fluidity, and guides the shaping material to the ejection unit 130. In the embodiment, the term “plasticize” refers to a concept including melting and refers to changing a solid state to a fluid state.

Specifically, in the case of a material in which glass transition occurs, “plasticize” refers to setting a temperature of the material to be equal to or higher than a glass transition point. For a material in which glass transition does not occur, “plasticize” refers to setting a temperature of the material to a temperature equal to or higher than a melting point. The shaping material may be a material containing a crystalline resin or an amorphous resin. In the embodiment, the shaping material contains a crystalline resin. Therefore, for example, a resin such as polyethylene, polypropylene, POM, and PEEK is used as the raw material MR.

The plasticizing unit 120 includes a screw case 121, a drive motor 122, a flat screw 140, and a barrel 150. The flat screw 140 is also referred to as a rotor or a scroll. The barrel 150 is also referred to as a screw facing portion.

The flat screw 140 is accommodated in the screw case 121. An upper surface 140a of the flat screw 140 is coupled to the drive motor 122. The flat screw 140 is rotated in the screw case 121 by a rotational drive force generated by the drive motor 122. The drive motor 122 is driven under the control of the control unit 500. The flat screw 140 may be driven by the drive motor 122 via a decelerator.

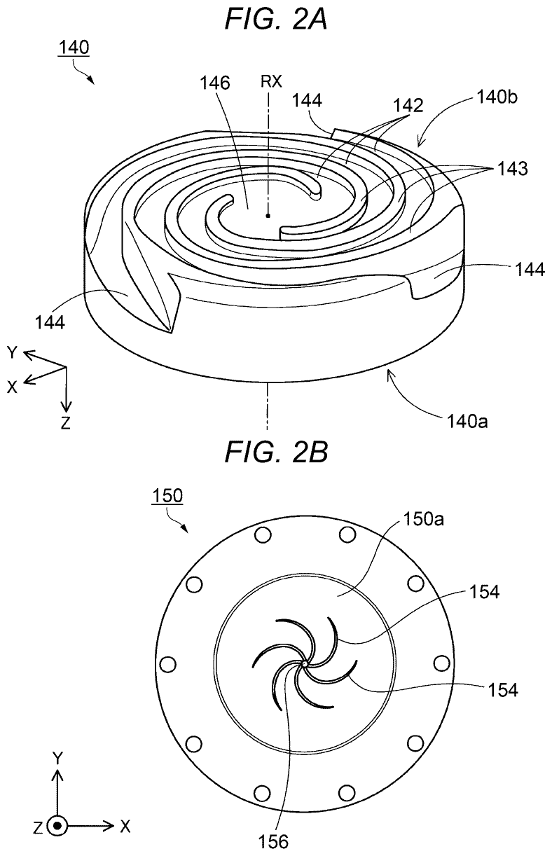

A lower surface 140b of the flat screw 140 faces an upper surface 150a of the barrel 150. The lower surface 140b of the flat screw 140 is formed with spaces between grooves 142 and the upper surface 150a of the barrel 150. The raw material MR is supplied to these spaces from the material supply unit 110 through material inlets 144 (see FIG. 2A).

A barrel heater 158 for heating the raw material MR supplied into the grooves 142 of the rotating flat screw 140 is embedded in the barrel 150. A communication hole 156 is provided at the center of the barrel 150.

The ejection unit 130 includes a nozzle 131 that ejects the shaping material, a shaping material flow path 133 that is formed between the flat screw 140 and a nozzle opening 132, and an ejection control unit 160 that controls the ejection of the shaping material.

The nozzle 131 is coupled to the communication hole 156 of the barrel 150 through the flow path 133. The nozzle 131 ejects the shaping material generated by the plasticizing unit 120, from the nozzle opening 132 at a distal end toward the stage 200.

The ejection control unit 160 includes an ejection adjustment unit 161 that opens and closes the flow path 133 and a suction unit 162 that suctions and temporarily stores the shaping material. The ejection adjustment unit 161 is provided in the flow path 133 and changes an opening degree of the flow path 133 when the ejection adjustment unit 161 rotates in the flow path 133.

In the present embodiment, the ejection adjustment unit 161 is implemented by a butterfly valve. The ejection adjustment unit 161 is driven by a first drive unit 171 under the control of the control unit 500. The first drive unit 171 is implemented by, for example, a stepping motor. The control unit 500 can control a rotation angle of the butterfly valve by using the first drive unit 171, thereby adjusting a flow rate of the shaping material flowing from the plasticizing unit 120 to the nozzle 131, that is, an ejection amount of the shaping material ejected from the nozzle 131. The ejection adjustment unit 161 can adjust an ejection amount of the shaping material and can control ON and OFF of outflow of the shaping material.

The suction unit 162 is coupled between the ejection adjustment unit 161 and the nozzle opening 132 in the flow path 133. The suction unit 162 temporarily suctions the shaping material in the flow path 133 when ejection of the shaping material from the nozzle 131 is stopped, thereby preventing a trailing phenomenon in which the shaping material hangs down like a string from the nozzle opening 132.

In the present embodiment, the suction unit 162 is implemented by a plunger. The suction unit 162 is driven by a second drive unit 172 under the control of the control unit 500. The second drive unit 172 is implemented by, for example, a stepping motor or a rack-and-pinion mechanism that converts a rotational force generated by the stepping motor into a translational motion of the plunger.

The stage 200 is disposed at a position facing the nozzle opening 132 of the nozzle 131. The stage 200 is disposed parallel to the X and Y directions, that is, a horizontal direction. The stage 200 has a shaping surface 200a on which the object 700 is shaped.

For example, a sacrificial layer 600 for forming the object 700 is formed on the stage 200. The object 700 is formed on the sacrificial layer 600.

The movement mechanism 300 changes a relative position between the stage 200 and the nozzle 131 under the control of the control unit 500. In the present embodiment, a position of the nozzle 131 is fixed, and the movement mechanism 300 moves the stage 200. The movement mechanism 300 is implemented by a three-axis positioner that moves the stage 200 in three axial directions, that is, the X, Y, and Z directions, by drive forces of three motors.

The control unit 500 is a control device that controls operations of the entire three-dimensional shaping apparatus 1000. The control unit 500 is implemented by a computer including one or more processors 510, a storage device 520 including a main storage device and an auxiliary storage device, and an input and output interface for inputting and outputting a signal from and to the outside. The control unit 500 and the information processing device 400 are communicably coupled to each other.

The processor 510 executes a program stored in the storage device 520 to control the shaping unit 100 and the movement mechanism 300 according to shaping data acquired from the information processing device 400, thereby shaping the object 700 on the stage 200. The control unit 500 may be implemented by combining circuits together, instead of being implemented by a computer.

Next, a configuration of the flat screw 140 will be described with reference to FIG. 2A.

The flat screw 140 shown in FIG. 2A is shown in a state where a positional relationship between the upper surface 140a and the lower surface 140b shown in FIG. 1 is reversed in a vertical direction. The flat screw 140 has a substantially cylindrical shape whose length in an axial direction that is a direction along a central axis thereof is shorter than a length in a direction perpendicular to the axial direction. The flat screw 140 is disposed in such a way that a rotation axis RX that is a rotation center thereof is parallel to the Z direction.

In the flat screw 140, the grooves 142 each having a vortex shape are formed in the lower surface 140b which is a surface crossing the rotation axis RX. The communication path 111 of the material supply unit 110 communicates with the grooves 142 from a side surface of the flat screw 140. In the present embodiment, three of the grooves 142 are formed by being separated from one another by protruding portions 143. The number of the grooves 142 is not limited to three and may be one, or two or more. The grooves 142 are not limited to have the vortex shape and may have a spiral shape or an involute curve shape, or may have a shape extending to draw an arc from a central portion toward an outer circumference.

Next, a configuration of the barrel 150 will be described with reference to FIG. 2B.

As shown in FIG. 2B, the upper surface 150a of the barrel 150 are formed with a plurality of guide grooves 154 that are coupled to the communication hole 156 and extend in a vortex shape from the communication hole 156 toward the outer circumference. One end of the guide groove 154 may not be coupled to the communication hole 156. The guide grooves 154 may be omitted.

The raw material MR supplied into the grooves 142 of the flat screw 140 flows along the grooves 142 due to rotation of the flat screw 140 while being plasticized in the grooves 142, and is guided to a central portion 146 of the flat screw 140 as the shaping material. The paste-shaped shaping material exhibiting fluidity, which flows into the central portion 146, is supplied to the ejection unit 130 via the communication hole 156 provided at the center of the barrel 150.

In the shaping material, not all kinds of substances constituting the shaping material may be plasticized. The shaping material may be converted into a fluid state as a whole by plasticizing at least a part of the substances constituting the shaping material.

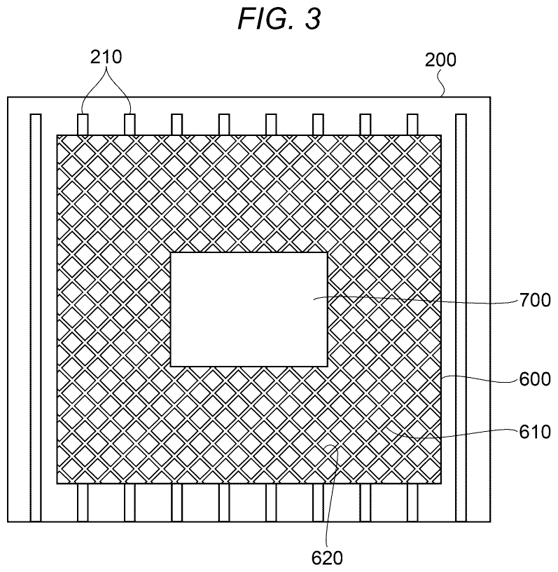

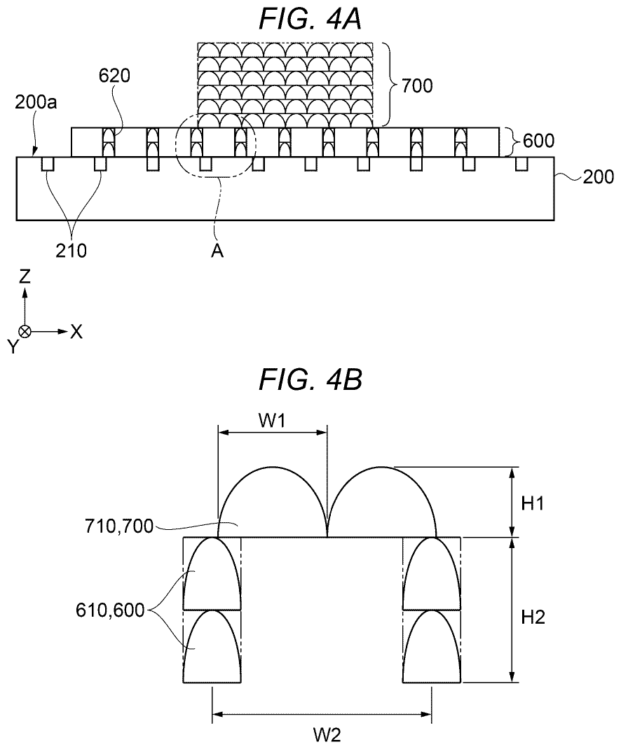

Next, configurations of the sacrificial layer 600 and the object 700 will be described with reference to FIGS. 3, 4A, and 4B.

As shown in FIGS. 3, 4A, and 4B, the sacrificial layer 600 is formed on the stage 200. The object 700 is formed on the sacrificial layer 600. In other words, the sacrificial layer 600 is used for forming the object 700. The sacrificial layer 600 is separated from the object 700 after the object 700 is formed.

The stage 200 is formed of, for example, stainless steel. A plurality of grooves 210 are formed in the shaping surface 200a of the stage 200. The grooves 210 are provided to increase adhesion with the object 700, specifically, adhesion with the sacrificial layer 600 for forming the object 700.

As described above, the sacrificial layer 600 is formed for forming the object 700. The sacrificial layer 600 is formed to have a recessed portion 620 at least in a portion in contact with the object 700. Specifically, in the sacrificial layer 600, a sacrificial layer material 610 serving as a first material is formed in a grid shape. An interval between the sacrificial layer material 610 and the sacrificial layer material 610 that are formed in a grid shape is the recessed portion 620. The sacrificial layer 600 is formed by stacking one or more sacrificial layer materials 610.

In this manner, since the grid-shaped sacrificial layer 600 is formed on the stage 200, it is possible to cause a part of the object 700 to enter the grid-shaped recessed portion 620, and it is possible to ensure adhesion between the object 700 and the sacrificial layer 600. Accordingly, quality of the object 700 can be improved. Since the grid-shaped sacrificial layer 600 is formed on the stage 200 formed with the grooves 210, when the object 700 is formed on the sacrificial layer 600, it is possible to prevent the object 700 from entering the grooves 210 of the stage 200, and it is possible to prevent the adhesion from becoming excessively high. Accordingly, after the object 700 is shaped, the sacrificial layer 600 and the object 700 can be separated from each other.

The sacrificial layer material 610 serving as the first material for forming the sacrificial layer 600 and an object material 710 serving as a second material for forming the object 700 are different materials. The sacrificial layer material 610 is, for example, a resin such as Poly oxy methylene (POM). The object material 710 is, for example, poly propylene (PP) talc.

In this manner, since the sacrificial layer material 610 and the object material 710 are different materials, and the different materials are brought into contact with each other, the object 700 and the sacrificial layer 600 can be easily separated from each other after the object 700 is formed. That is, it is possible to ensure separability between the object 700 after shaping and the sacrificial layer 600 while ensuring adhesion between the object 700 during shaping and the sacrificial layer 600.

A sliding property of the sacrificial layer material 610 is preferably higher than that of the object material 710. In this manner, since a material having a high sliding property is used for the sacrificial layer material 610, shaping can be performed using a material suitable for the purpose without considering a sliding property of the object material 710, and a selection range of a material of the object 700 can be widened.

As shown in FIG. 4B, an interval between the sacrificial layer material 610 and the sacrificial layer material 610 of the sacrificial layer 600, that is, a grid interval W2 is larger than a w width between the object material 710 and the object material 710 of the object 700 in contact with the sacrificial layer 600 at least, that is, a line width W1. Specifically, the grid interval W2 of the sacrificial layer 600 is 1.86 times or more the line width W1 of the object 700.

In this manner, since the grid interval W2 of the sacrificial layer 600 is larger than the line width W1 of the object 700, adhesion between the sacrificial layer 600 and the object 700 can be ensured, and separability can be ensured.

A depth of the grid of the sacrificial layer 600, that is, a depth H2 of the sacrificial layer 600 formed by a plurality of the sacrificial layer materials 610 is larger than a thickness of one layer of the object 700 in contact with the sacrificial layer 600 at least, that is, a thickness H1 of the object material 710. Specifically, the depth H2 of the sacrificial layer 600 is 2.5 times or more the thickness H1 of one layer of the object material 710 in contact with the sacrificial layer 600 at least.

In this manner, since the depth H2 of the grid of the sacrificial layer 600 is larger than the thickness H1 of one layer of the object material 710, it is possible to ensure separability between the sacrificial layer 600 and the object 700 while maintaining adhesion between the sacrificial layer 600 and the object 700.

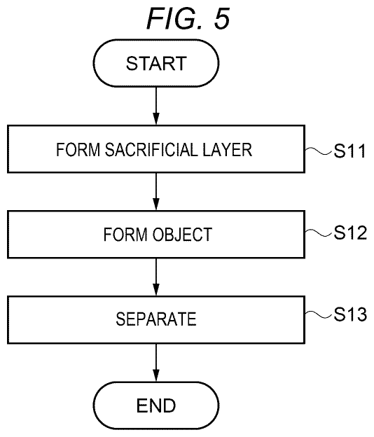

Next, a method for manufacturing the object 700 will be described with reference to FIGS. 5 to 8B.

First, as shown in FIG. 5, the sacrificial layer 600 is formed in step S11. Before the sacrificial layer 600 is formed, the grooves 210 provided in the stage 200 are preferably planarized by being filled with the sacrificial layer material 610.

In this manner, since the sacrificial layer 600 is formed on the stage 200 in which the grooves 210 are filled, it is possible to prevent excessive adhesion between the sacrificial layer 600 and the stage 200, and it is possible to easily peel the sacrificial layer 600 from the stage 200.

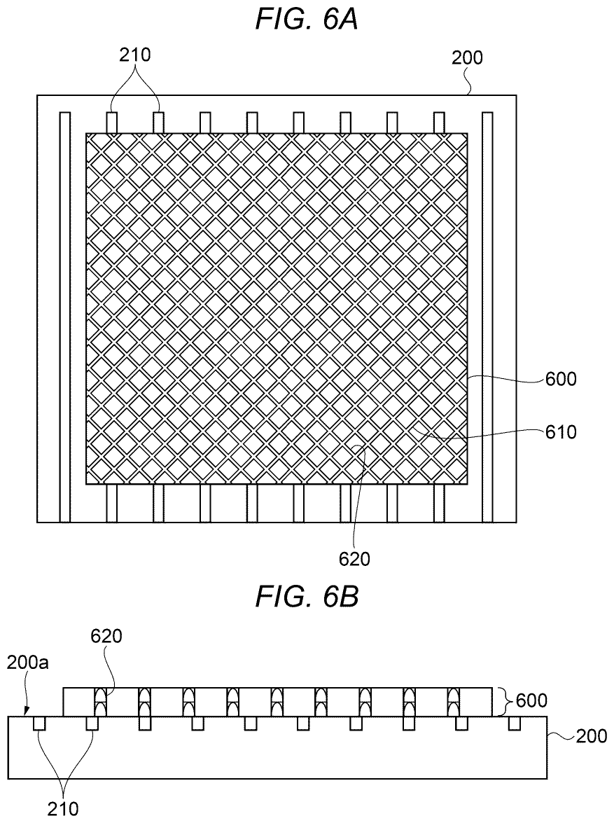

As shown in FIGS. 6A and 6B, the sacrificial layer material 610 made of POM is ejected onto the planarized stage 200 to form the grid-shaped sacrificial layer 600. The sacrificial layer 600 is the grid-shaped sacrificial layer 600 including the recessed portion 620 described above.

The grid-shaped sacrificial layer 600 is preferably shaped by lines having different angles in the same layer. The same sacrificial layer material 610 is stacked thereon. In this manner, since the grid-shaped sacrificial layers 600 are formed by lines having different angles in the same layer, it is possible to prevent the formation of a step in a height direction in a portion where the sacrificial layer materials 610 intersect each other, and it is possible to maintain balance between adhesion and separability.

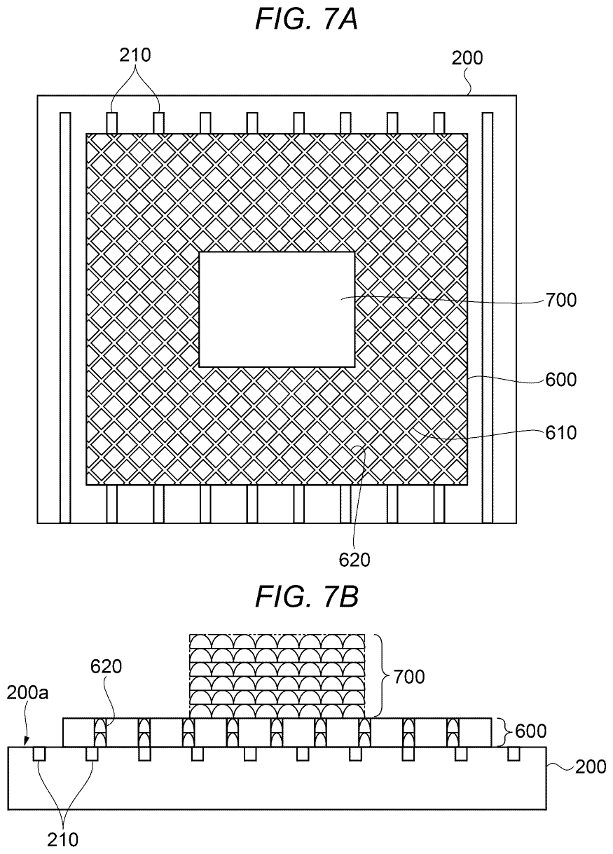

In step S12, the object 700 is formed. Specifically, as shown in FIGS. 7A and 7B, the object material 710 made of PP talc is ejected onto the sacrificial layer 600 to form the object 700.

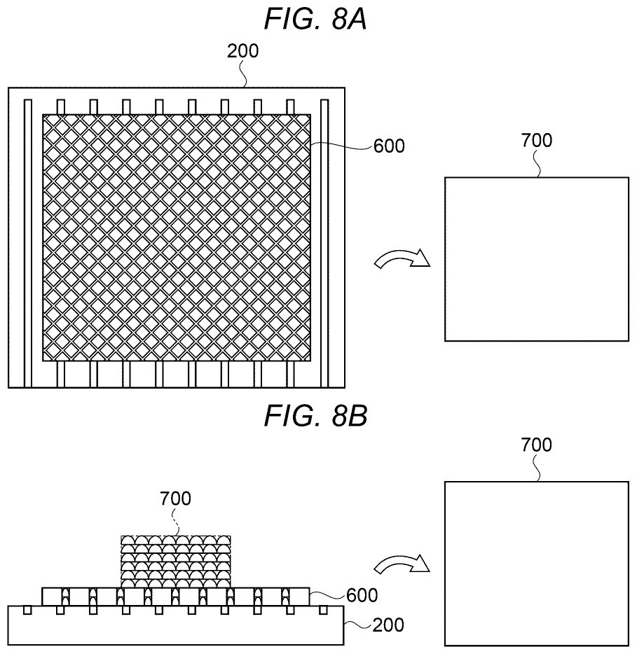

In step S13, the sacrificial layer 600 and the object 700 are separated from each other. Specifically, as shown in FIGS. 8A and 8B, after shaping of the object 700 is completed, the sacrificial layer 600 and the object 700 are separated from each other. In this manner, since the object 700 is shaped on the grid-shaped sacrificial layer 600 and further a material of the sacrificial layer 600 and a material of the object 700 are different, the sacrificial layer 600 and the object 700 can be easily separated from each other. In other words, it is possible to ensure separability between the object 700 after shaping and the sacrificial layer 600 while ensuring adhesion between the object 700 during shaping and the sacrificial layer 600.

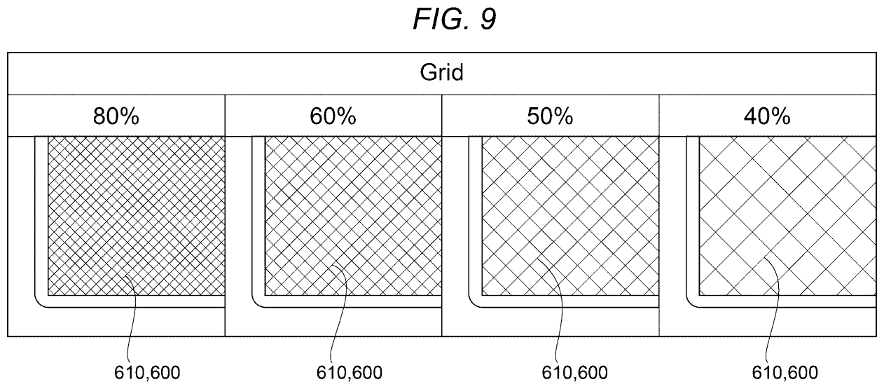

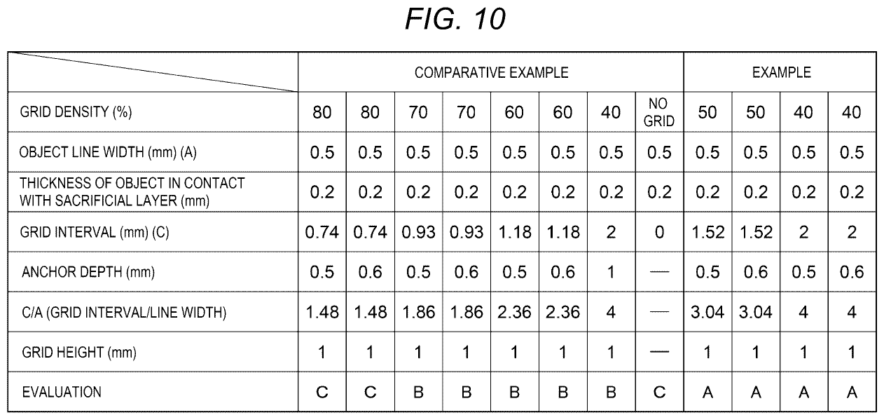

Next, evaluation of the sacrificial layer 600 when a formation condition of the sacrificial layer 600 is changed will be described with reference to FIGS. 9 and 10.

FIG. 9 shows an image when grid densities of the sacrificial layer 600 are 80%, 60%, 50%, and 40%. For example, when the grid density is 80%, the grid density refers to a density in which a pattern having a surface area of 40% and a pattern having the same surface area of 40% are overlapped perpendicularly to each other.

A table shown in FIG. 10 shows comparison between a comparative example and an example when a formation condition of the sacrificial layer 600 is changed. Evaluation A indicates that shaping can be performed and the sacrificial layer 600 can be reused. Evaluation B indicates that shaping can be performed but the sacrificial layer 600 cannot be reused. Evaluation C indicates that shaping cannot be performed.

“Shaping can be performed” refers to that the sacrificial layer 600 and the object 700 are not peeled off from each other during shaping. “The sacrificial layer 600 can be reused” refers to that the object 700 and the sacrificial layer 600 have good removability and a part of the object 700 is not left in the sacrificial layer 600.

As shown in FIG. 10, in the comparative example, when the grid density is 80% and when there is no grid, evaluation C is determined, and shaping cannot be performed. The reason why evaluation C is determined when the grid density is 80% is that a part of the object 700 does not enter the grid.

When the grid density is 70% and 60%, evaluation B is determined, and the sacrificial layer 600 cannot be reused. In a case where the grid density was 40%, when an anchor depth, that is, a depth at which a part of the object 700 enters the grid was 1 mm, evaluation B was determined.

Next, in the example, when the grid density is 50% and 40%, evaluation A is determined, shaping can be performed, and the sacrificial layer 600 can be reused. When the grid density is 40%, the anchor depth, that is, the depth at which a part of the object 700 enters the grid is preferably 0.5 mm or 0.6 mm.

As described above, when the sacrificial layer 600 is formed under a condition in which evaluation A is determined, it is possible to reuse the sacrificial layer 600 without impairing a shape of the object 700, and thus it is possible to reduce time and cost in subsequent shaping.

When the sacrificial layer 600 is formed under a condition in which evaluation B is determined, although the sacrificial layer 600 cannot be reused, it is possible to shape an object that cannot be shaped and is peeled off during shaping in the related art.

As described above, the method for manufacturing the object 700 according to the present embodiment includes a step of forming one or more sacrificial layers 600 by ejecting the sacrificial layer material 610 onto the stage 200, a step of forming the object 700 by ejecting the object material 710 onto the sacrificial layer 600, and a step of separating the object 700 and the sacrificial layer 600. The sacrificial layer material 610 and the object material 710 are different materials. In the step of forming the sacrificial layer 600, the sacrificial layer 600, which includes the recessed portions 620 into which a part of the object 700 enters, is formed at least in a portion in contact with the object 700.

According to the method, the sacrificial layer material 610 is used for the sacrificial layer 600, the object material 710 is used for the object 700, and different materials are brought into contact with each other. Therefore, the object 700 and the sacrificial layer 600 can be easily separated from each other after the object 700 is formed, and the sacrificial layer 600 can be repeatedly used. Since the sacrificial layer 600 is formed in a manner of including the recessed portions 620 into which a part of the object 700 enters, adhesion between the sacrificial layer 600 and the object 700 can be improved. That is, it is possible to ensure separability between the object 700 after shaping and the sacrificial layer 600 while ensuring adhesion between the object 700 during shaping and the sacrificial layer 600.

In the method for manufacturing the object 700 according to the present embodiment, in the step of forming the sacrificial layer 600, it is preferable to form the sacrificial layer 600 in a grid shape on the stage 200. According to the method, since the sacrificial layer 600 is formed in a grid shape on the stage 200, when the object 700 is formed on the sacrificial layer 600, it is possible to prevent adhesion from becoming excessively high.

In the method for manufacturing the object 700 according to the present embodiment, the grid interval W2 of the sacrificial layer 600 is preferably larger than the line width W1 of the object 700 in contact with the sacrificial layer 600 at least. According to the method, since the grid interval W2 of the sacrificial layer 600 is larger than the line width W1 of the object 700, adhesion between the sacrificial layer 600 and the object 700 can be ensured, and separability can be ensured.

In the method for manufacturing the object 700 according to the present embodiment, the grid interval W2 is preferably 1.86 times or more the line width W1 of the object 700. According to the method, since the grid interval W2 is larger by the above multiple, adhesion between the sacrificial layer 600 and the object 700 can be ensured, and separability can be ensured.

In the method for manufacturing the object 700 according to the present embodiment, it is preferable that the sacrificial layer 600 has a higher sliding property than the object 700. According to the method, since a material having a high sliding property is used for the sacrificial layer 600, shaping can be performed using a material suitable for the purpose without considering a sliding property of a material of the object 700, and a selection range of the material of the object 700 can be widened.

In the method for manufacturing the object 700 according to the present embodiment, the groove 210 is provided in the stage 200, and the method further includes a step of filling the groove 210 of the stage 200 with the sacrificial layer material 610 by ejecting the sacrificial layer material 610 into the groove 210 before forming the sacrificial layer 600. In the step of forming the sacrificial layer 600, it is preferable to form the sacrificial layer 600 on the stage 200 in which the grooves 210 are filled with the sacrificial layer material 610. According to the method, since the sacrificial layer 600 is formed on the stage 200 in which the grooves 210 are filled, it is possible to prevent excessive adhesion between the sacrificial layer 600 and the stage 200, and it is possible to easily peel the sacrificial layer 600 and the object 700 from the stage 200.

In the method for manufacturing the object 700 according to the present embodiment, in the step of forming the sacrificial layer 600 in a grid shape, it is preferable to stack grid-shaped layers shaped by lines having different angles in the same layer. According to the method, since the sacrificial layers 600 in a grid shape are formed by lines having different angles in the same layer, it is possible to prevent the formation of a step in a height direction, and it is possible to maintain balance between adhesion and separability.

A modification of the above embodiment will be described below.

As described above, the groove 210 is provided in the stage 200, the present disclosure is not limited thereto, and a stage in which no groove 210 is provided in advance may be used as the stage 200.

As described above, the object material 710 is ejected onto the sacrificial layer 600 to form the object 700, the present disclosure is not limited thereto, the sacrificial layer 600 and the object 700 may not be in direct contact with each other, and a raft constituting a part of the object 700 may be formed between the sacrificial layer 600 and the object 700. The raft is a base portion for preventing a bottom surface of the object 700 from becoming rough, and is a layer that is finally separated from a finished product.

For example, manufacturing conditions of the raft are as follows. A line width is 0.5 mm. A line height is 0.2 mm. A material is PP talc. A total number is eight layers. A thickness is 1.6 mm. A first layer has the same head ejection condition to fill an anchor, but a scanning speed is 30% of a scanning speed of second and subsequent layers. The scanning speed of the second and subsequent layers is 50 mm/s.

What is claimed is:

1. A method for manufacturing a three-dimensional object, the method comprising:
a step of forming one or more sacrificial layers by ejecting a first material onto a stage;
a step of forming an object by ejecting a second material onto the sacrificial layer; and
a step of separating the object and the sacrificial layer, wherein
the first material and the second material are different materials, and
in the step of forming the sacrificial layer, the sacrificial layer, which includes a recessed portion into which a part of the object enters, is formed at least in a portion in contact with the object.

2. The method for manufacturing a three-dimensional object according to claim 1, wherein
in the step of forming the sacrificial layer, the sacrificial layer having a grid shape is formed on the stage.

3. The method for manufacturing a three-dimensional object according to claim 2, wherein
a grid interval of the sacrificial layer is larger than at least a line width of the object in contact with the sacrificial layer.

4. The method for manufacturing a three-dimensional object according to claim 3, wherein
the grid interval is 1.86 times or more the line width of the object.

5. The method for manufacturing a three-dimensional object according to claim 1, wherein
the sacrificial layer has a higher sliding property than the object.

6. The method for manufacturing a three-dimensional object according to claim 1, wherein
a groove is provided in the stage,
the method further comprising:
a step of filling the groove of the stage with the first material by ejecting the first material into the groove before forming the sacrificial layer, and
in the step of forming the sacrificial layer, the sacrificial layer is formed on the stage in which the groove is filled with the first material.

7. The method for manufacturing a three-dimensional object according to claim 2, wherein
in the step of forming the sacrificial layer having the grid shape, grid-shaped layers shaped by lines having different angles in the same layer are stacked.
